(19) United States
(12) Patent Application Publication
(10) Pub. No.: US 2019/0014354 A1
(43) Pub. Date: Jan. 10, 2019

(54) INCREASING ENGAGEMENT WITH SHARED CONTENT

(71) Applicant: Sergey Ioffe, Mountain View, CA (US)

(72) Inventor: Sergey Ioffe, Mountain View, CA (US)

(73) Assignee: Google Inc., Mountain View, CA (US)

(21) Appl. No.: 13/477,921

(22) Filed: May 22, 2012

(51) Int. Cl. H04N 21/2183

(52) U.S. Cl. CPC H04N 21/2183

(57) ABSTRACT

Methods and systems are disclosed for estimating a user's ability to share content that is of interest to recipients, and of informing a recipient of this ability when the user shares content with the recipient. In one embodiment, a computer system receives an indication that a first user wishes to share a content item (e.g., a video clip, a photo, an audio clip, a webpage, etc.) with a second user. In response, the computer system obtains data pertaining to a prior history of interaction by the second user with content that the first user has previously shared with the second user; determines, based on the obtained data, an estimate of an ability of the first user to predict an interest in the content item by the second user; and provides the estimate to the second user.

### TECHNICAL FIELD

Embodiments of the present disclosure relate to data processing, and more specifically, to sharing content among users.

### BACKGROUND

Sharing of content (e.g., video clips, photos, audio clips, webpages, etc.) via the Internet is becoming pervasive, due in part to the growing popularity of social networks and content hosting websites. For example, a user of a social network or content hosting website may share a particular content item with some or all of his connections (also known as “followers” or “friends”), either publicly (e.g., by including the content item in a status update, by including the content item in a post to a connection's “wall,” etc.) or privately (e.g., via an email message, via a private message in the social network, etc.)

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In an embodiment of the present disclosure, a computer system receives an indication that a first user wishes to share a content item (e.g., a video clip, a photo, an audio clip, a webpage, etc.) with a second user. As used herein, a user may be an individual, a business entity, a web bot (a software application that runs an automated task over the Internet), or any other program or organization. In response, the computer system obtains data pertaining to a prior history of interaction by the second user with content that the first user has previously shared with the second user; determines, based on the obtained data, an estimate of an ability of the first user to predict an interest in the content item by the second user; and provides the estimate to the second user.

In addition, methods and systems for performing the operations of the above described embodiments are also implemented. Further, a computer readable storage media is provided to store instructions for performing the operations of the above described embodiments.

### BRIEF DESCRIPTION OF THE DRAWINGS

Embodiments of the present disclosure will be understood more fully from the detailed description given below and from the accompanying drawings of various embodiments of the disclosure, which, however, should not be taken to limit the invention to the specific embodiments, but are for explanation and understanding only.

FIG. 1 illustrates an exemplary system architecture, in accordance with one embodiment of the present disclosure.

FIG. 2 is a block diagram of one embodiment of a content sharing manager.

FIG. 3 depicts a flow diagram of one embodiment of a method for managing user sharing of content.

FIG. 4 depicts a block diagram of an illustrative computer system operating in accordance with embodiments of the disclosure.

### DETAILED DESCRIPTION

Methods and systems are disclosed for estimating a user's ability to share content that is of interest to recipients, and of informing a recipient of this ability when the user shares content with the recipient. In particular, when a first user wishes to share a content item (e.g., a video clip, a photo, an audio clip, a webpage, etc.) with a second user, the computer system estimates, based on a prior history of interaction by the second user with content that the first user has shared with the second user, an ability of the first user to predict an interest in the content item by the second user. The computer system then provides this estimate to the second user.

In one embodiment, when a first user wishes to share a content item with a second user, a computer system generates two scores:
a “pairwise” ability score that estimates an ability of the first user to predict the second user's interest in the content item; and
a “global” ability score that estimates a general ability of the first user to predict recipients' interest in content shared by the first user;
and provides both of these scores to the second user with the shared content item.

In one embodiment, the above scores are estimated based on past sharing of content by users. In particular, the pairwise ability score for a first user and a second user is estimated based on a prior history of interaction by the second user with content that the first user has shared with the second user, such as:
the second user clicking on a link that is shared by the first user with the second user;
the viewing behavior of a second user when viewing a video (e.g., a video clip) shared by the first user with the second user (e.g., how much time the second user spends watching the video clip, how many times the second user viewed the video clip, etc.);
the second user redistributing the content to other users;
the second user replying to a message from the first user that shares the content (e.g., an email message, a private message delivered via the social network, etc.); and
the second user providing positive feedback (e.g., “Like!”, etc.) to content that the first user shared publicly (e.g., included in a status update in the social network, etc.).

In accordance with one embodiment, the global ability score for a user is similarly estimated, based on a prior history of interaction by any recipient of content shared by the user. The pairwise and global ability scores may be based on both private sharing of content (e.g., via an email message from a user to one or more recipients, via a private message in the social network from a user to one or more recipients, etc.), and public sharing of content (e.g., via a posting on a user's “wall,” via a status update of a user that is broadcast to all of the user's followers, etc.).

In one embodiment, the computer system also assigns priorities, based on the ability scores, to messages that notify a user when another user has shared a content item with him or her. For example, an email message by which the sender shares a content item with the recipient (e.g., via an attachment, via a link, etc.) may be assigned a low priority—or perhaps even filed in a “junk” folder automatically—when the ability scores suggest that the recipient is unlikely to be interested in the content item.

Embodiments of the present disclosure thus enable a recipient of a shared content item to easily judge—based on the sharer's scores, or the assigned priority, or both—whether the content item is likely of interest. The recipient can then quickly decide whether to invest the time in the content item (e.g., by clicking on a link to a video clip and watching the video clip, etc.) or instead ignore the content item (e.g., by deleting an email message that delivers the shared content, ignoring the content shared on a social network website, etc.).

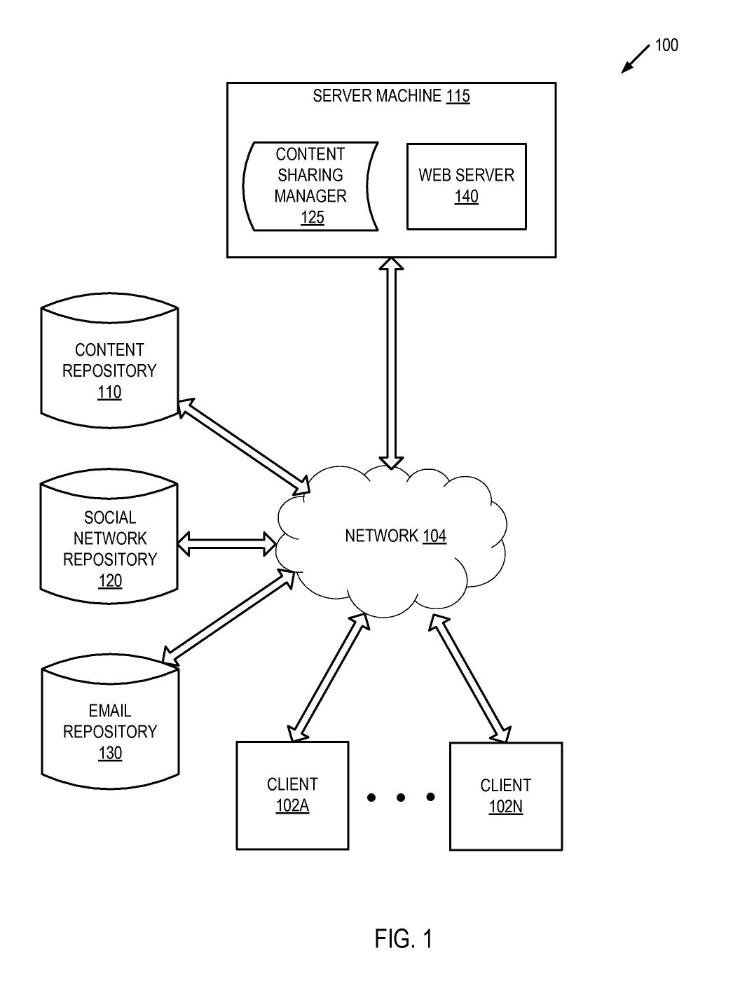

FIG. 1 illustrates an example system architecture 100, in accordance with one embodiment of the present disclosure. The system architecture 100 includes a server machine 115, a content repository 110, a social network repository 120, an email repository 120, and client machines 102A-102N connected to a network 104. Network 104 may be a public network (e.g., the Internet), a private network (e.g., a local area network (LAN) or wide area network (WAN)), or a combination thereof.

The client machines 102A-102N may be wireless terminals (e.g., smartphones, etc.), personal computers (PC), laptops, tablet computers, or any other computing or communication devices. The client machines 102A-102N may run an operating system (OS) that manages hardware and software of the client machines 102A-102N. A browser (not shown) may run on the client machines (e.g., on the OS of the client machines). The browser may be a web browser that can access content served by a web server. The browser may issue image and/or video search queries to the web server or may browse images and/or videos that have previously been classified. The client machines 102A-102N may also upload images and/or video to the web server for storage and/or classification.

Server machine 115 may be a rackmount server, a router computer, a personal computer, a portable digital assistant, a mobile phone, a laptop computer, a tablet computer, a camera, a video camera, a netbook, a desktop computer, a media center, or any combination of the above. Server machine 115 may include a web server 140 and a content sharing manager 125. In some embodiments server machine 115 may comprise a plurality of machines (e.g., a plurality of blade servers, etc.) rather than a single machine, and the web server 140 and content sharing manager 125 may run on different machines.

Content repository 110 is a persistent storage that is capable of storing content items (e.g., web pages, photos, video clips, audio clips, etc.) and data structures to tag, organize, and index the content items. In some embodiments content repository 110 might be a network-attached file server, while in other embodiments content repository 110 might be some other type of persistent storage such as an object-oriented database, a relational database, and so forth, that may be hosted by the server machine 115 or one or more different machines coupled to the server machine 115 via the network 104.

Social network repository 120 is a persistent storage that is capable of storing information concerning a social network, such as user profile information, links among users (e.g., undirected edges between users who are friends, directed edges between users and their followers, etc.), user actions (e.g., status updates, sharing a content item, “Like”ing another user's status update, etc.), content items uploaded by users (e.g., web pages, photos, video clips, audio clips, etc.), links to content items stored outside the social network, and so forth, as well as data structures to tag, organize, and index this information. In some embodiments social network repository 120 might be a network-attached file server, while in other embodiments social network repository 120 might be some other type of persistent storage such as an object-oriented database, a relational database, and so forth, that may be hosted by the server machine 115 or one or more different machines coupled to the server machine 115 via the network 104. The photos, video clips, and audio clips stored in the social network repository 120 may include user-generated content that is uploaded by client machines. The photos, video clips, and audio clips may additionally or alternatively include content provided by service providers such as news organizations, publishers, libraries and so on.

Email repository 130 is a persistent storage that is capable of storing email messages for users (e.g., users of a Web-based email service, etc.), content items attached to email messages, and data structures to tag, organize, and index this information. In some embodiments email repository 130 might be a network-attached file server, while in other embodiments email repository 130 might be some other type of persistent storage such as an object-oriented database, a relational database, and so forth, that may be hosted by the server machine 115 or one or more different machines coupled to the server machine 115 via the network 104.

Web server 140 may serve web pages and content from content repository 110 to clients 102A-102N, web pages and data from social network repository 120 to clients 102A-102N whose users are members of the social network, and web pages, email messages and attachments from email repository 130 to clients 102A-102N whose users have email accounts associated with email repository 130. In addition, web server 140 may receive uploaded content and data from clients 102A-102N (e.g., video clips, photos, status updates, profile changes, email messages, etc.) and store the content and data in content repository 110, social network repository 120 and email repository 130, as appropriate. It should be noted that in some embodiments web server 140 may comprise a plurality of distinct web servers (e.g., a web server for content, a web server for a social network website, a web server for an email service, etc.) rather than a single web server, each possibly running on a corresponding server machine.

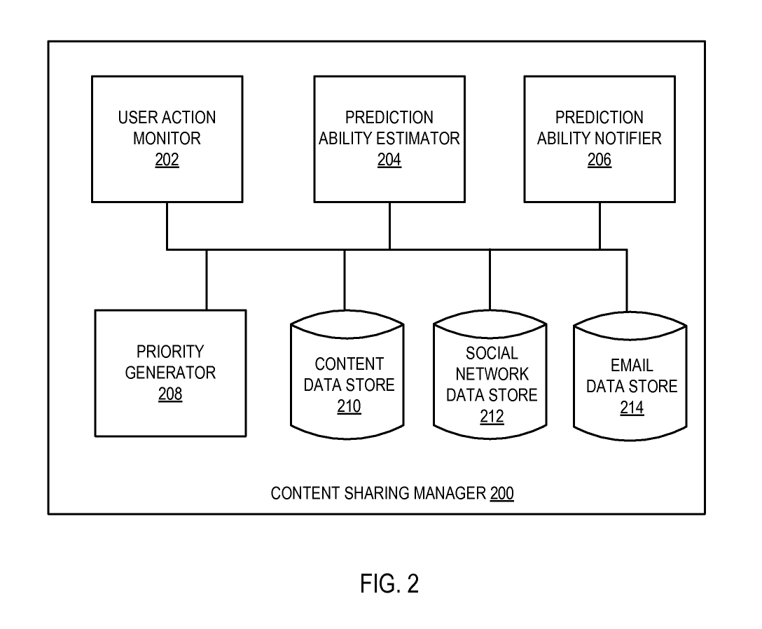

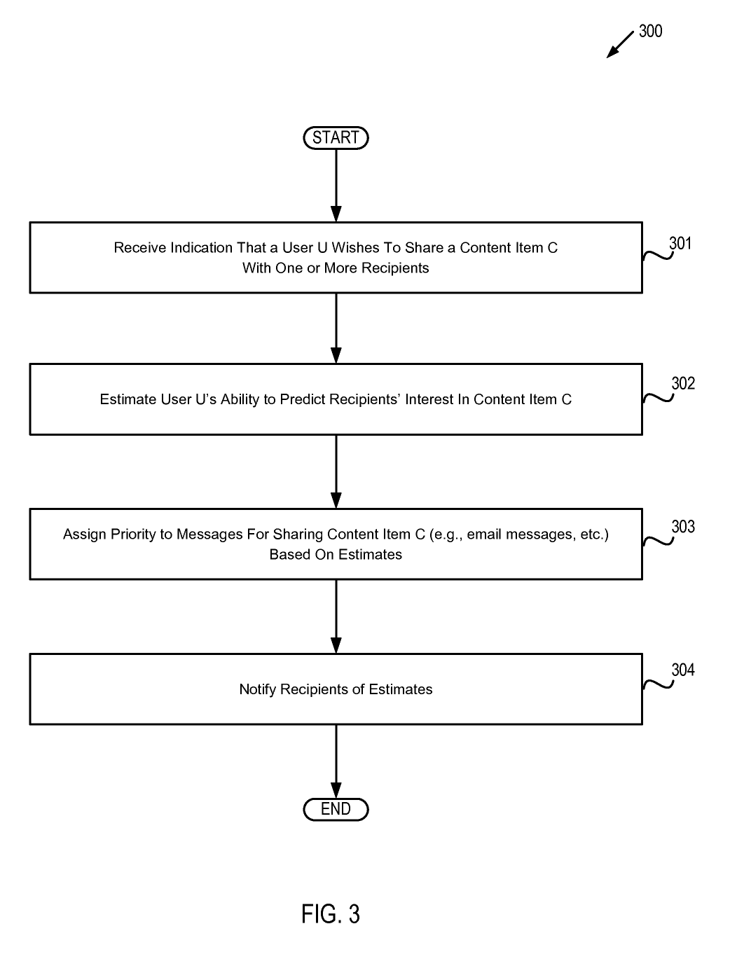

In accordance with some embodiments, content sharing manager 125 is capable of monitoring users' sharing of content with other users, of estimating the ability of users to predict recipients' interest in shared content, of notifying recipients of shared content of the sharer's ability to predict the recipients' interest in the shared content, and of determining and assigning priorities to messages for sharing content (e.g., email messages, status updates, private messages, etc.) based on the prediction ability estimates. An embodiment of content sharing manager 125 is described in detail below and with respect to FIGS. 2 and 3.

FIG. 2 is a block diagram of one embodiment of a content sharing manager 200. The content sharing manager 200 may be the same as the content sharing manager 125 of FIG. 1 and may include a user action monitor 202, a prediction ability estimator 204, a prediction ability notifier 206, a priority generator 208, a content data store 210, a social network data store 212, and an email data store 214. The components can be combined together or separated in further components, according to a particular embodiment.

The content data store 210 may be a permanent data store to hold content (e.g., photos, audio clips, video clips, etc.), web pages, data structures for organizing and indexing content in content data store 210, or some combination of these data. The social network data store 212 may be a permanent data store to hold web pages data pertaining to one or more users of the social network (e.g., user profile data, user actions, etc.), web pages that are served to users of the social network, data structures for organizing and indexing data in social network repository 120, or some combination of these data. The email data store 214 may be a permanent data store to hold email messages, attachments, web pages that are served to users who have email accounts associated with email repository 130, data structures for organizing and indexing data in email repository 130, or some combination of these data. Alternatively, one or more of content data store 210, social network data store 212, and email data store 214 may be hosted by one or more storage devices, such as main memory, magnetic or optical storage based disks, tapes or hard drives, NAS, SAN, and so forth. In one embodiment, the content sharing manager 200 notifies users of the types of information that are stored in content data store 210, social network data store 212, and email data store 214, and provides the users the opportunity to opt-out of having such information collected and/or shared with the content sharing manager 200.

The user action monitor 202 collects data concerning the actions of users, such as sharing content, and interacting with content that is shared with them (e.g., viewing a video clip shared with them, clicking on a link shared with them, “Like”ing content that is shared publicly, redistributing shared content, opening email messages, replying to email messages, etc.), and so forth. In one embodiment, these data may be collected from one or more of content repository 110, social network repository 120, and email repository 130.

The prediction ability estimator 204 generates scores of users' prediction ability when sharing content (e.g., the likelihood that when a particular user shares content with a recipient, the content is of interest to the recipient). In one embodiment, prediction ability estimator 204 generates two types of scores:
(1) a “pairwise” ability score for any ordered pair (user1, user2) that estimates an ability of user1 to predict user2's interest in content shared by user1; and
(2) a “global” ability score for a user that estimates the ability of the user to predict recipients' interest in content shared by the user.

In one embodiment, these scores are estimated based on past sharing of content by users. More particularly, the pairwise ability score for a first user and a second user is estimated based on a prior history of interaction by the second user with content that the first user has shared with the second user, such as:
the second user clicking on a link that is shared by the first user with the second user;
the viewing behavior of a second user when viewing a video clip shared by the first user with the second user (e.g., how much time the second user spends watching the video clip, etc.);
the second user redistributing the content to other users;
the second user replying to a message from the first user that shares the content (e.g., an email message, a private message delivered via the social network, etc.); and
the second user providing positive feedback (e.g., “Like!”, etc.) to content that the first user shared publicly (e.g., included in a status update in the social network, etc.).

In accordance with this embodiment, the global ability score for a user is similarly estimated, based on a prior history of interaction by any recipient of content shared by the user. The pairwise and global ability scores may be based on both private sharing of content (e.g., via an email message from a user to one or more recipients, via a private message in the social network from a user to one or more recipients, etc.), and public sharing of content (e.g., via a posting on a user's “wall,” via a status update of a user that is broadcast to all of the user's followers, etc.).

The prediction ability notifier 206 informs recipients of shared content of the sharer's prediction ability estimated by prediction ability estimator 204. In one embodiment, prediction ability notifier 206 informs a recipient of both the pairwise and global ability scores of the sharer when content is shared with the recipient.

The priority generator 208 determines and assigns priorities to messages for sharing content (e.g., email messages, status updates, private messages, etc.) based on the prediction ability estimates provided by prediction ability estimator 204. In one embodiment, when a first user shares content with a second user, priority generator 208 determines the priority based on a weighted average of the pairwise and global scores provided by prediction ability estimator 204, weighing the pairwise score more heavily than the global score.

FIG. 3 depicts a flow diagram of one embodiment of a method 300 for managing user sharing of content. The method is performed by processing logic that may comprise hardware (circuitry, dedicated logic, etc.), software (such as is run on a general purpose computer system or a dedicated machine), or a combination of both. For simplicity of explanation, the methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media. In one embodiment, the method is performed by the server machine 115 of FIG. 1, while in some other embodiments, one or more of blocks 301 through 304 might be performed by another machine. It should be noted that in some embodiments, various components of content sharing manager 200 may run on separate machines.

At block 301, an indication that a user U wishes to share a content item C with a set R of one or more recipients is received. This indication may be received in response to a variety of user actions, such as clicking on a “Share” link on a web page of the social network, attaching content item C to a status update in the social network, attaching content item C to an email message, embedding a link in an email message, and so forth. It should be noted that in some embodiments, the indication received at block 301 may also specify a particular mechanism for sharing content item C (e.g., via an email message, via a private message in a messaging system provided by a social network, via a status update in a social network, via posting on a recipient's “wall” in a social network, etc.). In accordance with one embodiment, block 301 is performed by user action monitor 202.

At block 302, an ability of user U to predict an interest in content item C by recipients is estimated. In one embodiment, a pairwise ability score is computed for each pair (U, r), where r is a recipient of set R, and a global ability score for user U is computed. For example, if user U indicated at block 301 that he or she wishes to share content item C with users X, Y, and Z, then in accordance with this embodiment the following ability scores are computed:
a pairwise ability score ability(U, X);
a pairwise ability score ability(U, Y);
a pairwise ability score ability(U, Z); and
a global ability score ability(U).

In one embodiment, these scores may be estimated based on past sharing of content by users. For example, pairwise ability score ability(U, X) may be estimated based on user X's prior history of interaction with content that user U has shared user X, such as any one or more of the following:
user X clicking on a link that user U shares with user X;
user X's viewing behavior when viewing a video clip that user U shares with user X (e.g., how much time user X spends watching the video clip, what fraction of the video clip user X watches, etc.);
user X redistributing the content to other users (e.g., forwarding via email, re-sharing via some social network mechanism, etc.);
user X replying to a message from user U that shares the content (e.g., an email message, a private message delivered via the social network, etc.); and
user X providing positive feedback when user U shares content publicly with user X (e.g., “Like!”, a positive comment, etc.).

In accordance with this embodiment, global ability score ability(U) is similarly estimated, based on a prior history of interaction by any recipient of content shared by user U. In one embodiment, block 302 is performed by prediction ability estimator 204.

It should be noted that in some other embodiments, the pairwise and global ability scores may be determined based on other criteria instead of, or in addition to, those enumerated above. Further, some other embodiments may determine the global ability score in a different fashion than the pairwise scores, rather than in a similar fashion.

It should also be noted that the ability scores may be determined in a variety of ways. For example and without limitation, in one embodiment, each of the criteria enumerated above may be assigned a rating of zero to five stars, and the score may be a simple or weighted average of these ratings. As another example, each of the criteria may be associated with a numerical value (e.g., how many times user X redistributed content shared by user U in the last 30 days, etc.), and a formula may be applied that results in a normalized score between 0 and 1, or a score between 0 and one hundred.

At block 303, a priority is assigned to each message for sharing content item C with recipients (e.g., email messages, private messages delivered via a social network, etc.) based on the estimates obtained at block 302. For example and without limitation, if an email message is the mechanism by which user U shares content item C with a user X, and pairwise and global ability scores are between 0 and 1 inclusive, then, in one embodiment, the email message might be assigned a priority as follows:
priority=high, when ability(U, X)+ability(U)≥1.5
priority=low, when ability(U, X)+ability(U)≤0.5
priority=normal, otherwise.

It should be noted that the above example is merely illustrative, and that other embodiments might employ alternative logic or formulae for assigning priorities, or might not assign priorities at all. It should also be noted that in some embodiments, priority generator 208 may also consider content item C when determining priorities. For example, if a content item C is specified by the link http://www.nygiants.com/article.html and an intended recipient has indicated in a social network that he “Likes” the New York Giants football team, then priority generator 208 might assign a high priority as long as ability(U, X)+ability(U) is at least 0.5, rather than the stricter threshold of 1.5 for other shared content. In one embodiment, block 303 is performed by priority generator 208.

At block 304, each recipient r of content item C is notified of both the pairwise ability score ability(U, r) and the global ability score ability(U) estimated at block 302. In some embodiments, this notification may be sent to a recipient together with content item C (e.g., within an email message that shares content item C, etc.), while in some other embodiments, this notification may be sent separately (e.g., via a separate email message, etc.). For example, in one embodiment, a user might receive the following email message:
John Smith has shared the following link with you:
   http://www.xyz.com/article.html
John Smith has a score of 86/100 for sharing content with you, and an overall sharing score of 78/100 for all of his followers.

In one embodiment, block 304 is performed by prediction ability notifier 206. In one embodiment, the prediction ability notifier 206 notifies user U that user U's ability to predict an interest in content item C by recipients will be estimated and provided to the recipients, and provides user U the opportunity to opt-out of having such information estimated and/or shared with other users.

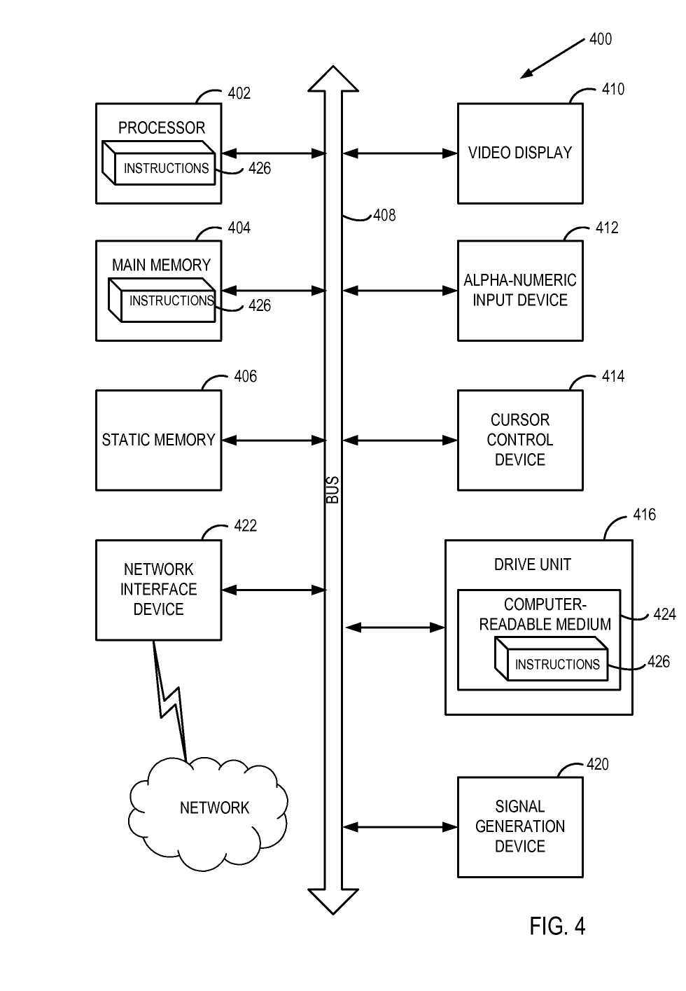

FIG. 4 illustrates an exemplary computer system within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 400 includes a processing system (processor) 402, a main memory 404 (e.g., read-only memory (ROM), flash memory, dynamic random access memory (DRAM) such as synchronous DRAM (SDRAM)), a static memory 406 (e.g., flash memory, static random access memory (SRAM)), and a data storage device 416, which communicate with each other via a bus 408.

Processor 402 represents one or more general-purpose processing devices such as a microprocessor, central processing unit, or the like. More particularly, the processor 402 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 402 may also be one or more special-purpose processing devices such as an application specific integrated circuit (ASIC), a field programmable gate array (FPGA), a digital signal processor (DSP), network processor, or the like. The processor 402 is configured to execute instructions 426 for performing the operations and steps discussed herein.

The computer system 400 may further include a network interface device 422. The computer system 400 also may include a video display unit 410 (e.g., a liquid crystal display (LCD) or a cathode ray tube (CRT)), an alphanumeric input device 412 (e.g., a keyboard), a cursor control device 414 (e.g., a mouse), and a signal generation device 420 (e.g., a speaker).

The data storage device 416 may include a computer-readable medium 424 on which is stored one or more sets of instructions 426 (e.g., instructions executed by content sharing manager 125 and corresponding to blocks 301 through 304 of FIG. 3, etc.) embodying any one or more of the methodologies or functions described herein. Instructions 426 may also reside, completely or at least partially, within the main memory 404 and/or within the processor 402 during execution thereof by the computer system 400, the main memory 404 and the processor 402 also constituting computer-readable media. Instructions 426 may further be transmitted or received over a network via the network interface device 422.

While the computer-readable storage medium 424 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the above description, numerous details are set forth. It will be apparent, however, to one of ordinary skill in the art having the benefit of this disclosure, that embodiments of the disclosure may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “determining,” “providing,” “transmitting,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the disclosure also relate to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.” Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion.

It is to be understood that the above description is intended to be illustrative, and not restrictive. Many other embodiments will be apparent to those of skill in the art upon reading and understanding the above description. Moreover, the techniques described above could be applied to other types of data instead of, or in addition to, video clips (e.g., images, audio clips, textual documents, web pages, etc.). The scope of the invention should, therefore, be determined with reference to the appended claims, along with the full scope of equivalents to which such claims are entitled.

1. A method comprising:
receiving, by a computer system, a first signal indicating a first request of a first user to share a first video with a second user;
determining an estimate of an ability of the first user to predict content that is of interest to the second user, wherein the estimate comprises a numerical value based on an interaction comprising a viewing time of the first video by the second user in response to the first user sharing the first video with the second user;
receiving a second signal indicating a second request of the first user to share a second video with the second user; and
notifying the second user, by the computer system, that the first user wishes to share the second video with the second user, wherein the notifying comprises causing a message including the estimate to be displayed to the second user.

2. The method of claim 1 wherein the interaction by the second user with the first video further comprises a click-through of a link associated with the first video.

3. The method of claim 1 wherein the interaction by the second user with the first video further comprises a re-share of the first video with a third user.

4. (canceled)

5. (canceled)

6. The method of claim 1 wherein the interaction with the first video further comprises positive feedback for the first video.

7. The method of claim 1 wherein the first video was shared with the second user via a message from the first user to the second user, and wherein the interaction with the first video further comprises a reply to the message.

8. The method of claim 1 wherein the method further comprises assigning a priority to the message based on the estimate.

9. The method of claim 1 wherein a prior history of the interaction is recorded in at least one of a content repository, a social network repository, or an email repository.

10. An apparatus comprising:
a network interface device; and
a processor to:
receive, via the network interface device, a first signal indicating a first request of a first user to share a first video with a second user;
determine an estimate of an ability of the first user to predict content that is of interest to the second user, wherein the estimate comprises a numerical value based on an interaction comprising a viewing time of the first video by the second user in response to the first user sharing the first video with the second user;
receive a second signal indicating a second request of the first user to share a second video with the second user; and
notify the second user that the first user wishes to share the second video with the second user, wherein the notifying comprises causing a message including the to be displayed to the second user.

11. The apparatus of claim 10 wherein the interaction by the second user with the first video further comprises a click-through of a link associated with the first video.

12. The apparatus of claim 10 wherein the interaction by the second user with the first video further comprises a re-share of the first video with a third user.

13. (canceled)

14. (canceled)

15. The apparatus of claim 10 wherein the interaction by the second user with the first video further comprises positive feedback for the first video.

16. The apparatus of claim 10 wherein the first video was shared with the second user via a message from the first user to the second user, and wherein the interaction by the second user with the first video further comprises a reply to the message.

17. The apparatus of claim 10 wherein the processor is further to: assign a priority to the message based on the estimate.

18. The apparatus of claim 10 wherein a prior history of the interaction is recorded in at least one of a content repository, a social network repository, or an email repository.

19-24. (canceled)

25. A non-transitory computer-readable storage medium comprising instructions that, when executed by a processor, cause the processor to:
receive a first signal indicating a first request of a first user to share a first video with a second user;
determine an estimate of an ability of the first user to predict content that is of interest to the second user, wherein the estimate comprises a numerical value based on an interaction comprising a viewing time of the first video by the second user in response to the first user sharing the first video with the second user;
receiving a second signal indicating a second request of the first user to share a second video with the second user; and
notify the second user, in response to the second indication, that the first user wishes to share the second video with the second user, wherein the notifying comprises causing a message including the estimate to be displayed to the second user.

26. The non-transitory computer-readable storage medium of claim 25 wherein the interaction by the second user with the first video further comprises a click-through of a link associated with the first video.

27. The non-transitory computer-readable storage medium of claim 25 wherein the interaction by the second user with the first video further comprises a re-share of the first video with a third user.

28. (canceled)

29. The non-transitory computer-readable storage medium of claim 25 wherein the first video was shared with the second user via a message from the first user to the second user, and wherein the interaction by the second user with the first video further comprises a reply to the message.

30. The non-transitory computer-readable storage medium of claim 25 wherein the instructions further cause the processor to assign a priority to the message based on the estimate.
